(19) United States
(12) Patent Application Publication
(10) Pub. No.: US 2012/0013586 A1
(43) Pub. Date: Jan. 19, 2012

(54) Method and device for driving bistable liquid crystal display panel

(76) Inventors: Masafumi Hoshino, Chiba (JP); Shinichi Nogawa, Chiba (JP); Hisayuki Hirayama, Chiba (JP)

(21) Appl. No.: 13/138,439

(22) PCT Filed: Feb. 9, 2010
(86) PCT No.: PCT/JP2010/051861

§ 371 Date: Sep. 28, 2011

(30) Foreign Application Priority Data
Feb. 17, 2009 (JP) 2009-034314

(51) Int. Cl. G09G 3/36; G09G 5/00

(52) U.S. Cl. 345/209; 345/96

(57) ABSTRACT

In a method of driving a dot matrix display panel using bistable nematic liquid crystal, a “blur” due to a parasitic signal is prevented from being caused. In a method of driving a dot matrix display panel using bistable nematic liquid crystal which may select white/black only by positive polarity driving or negative polarity driving, a direct current component due to a parasitic signal (40) caused at the time of non-selection is canceled by a cancel pulse (41) having a pulse width that is the same as that of the parasitic signal (40) and a polarity that is opposite to that of the parasitic signal (40). The cancel pulse (41) is generated by adding an additive pulse (35) to a common selection signal (25) and by adding an additive pulse (36) to a common non-selection signal (26).

### TECHNICAL FIELD

The present invention relates to a method and a device for driving a bistable liquid crystal display panel, and more particularly, to a method and a device for driving a dot matrix display panel using bistable nematic liquid crystal.

### BACKGROUND ART

Conventionally, a display method using characteristics of bistable nematic liquid crystal is known.

This display method using liquid crystal is described based on schematic views of parts (g) and (h) of FIG. 2 illustrating structures of liquid crystal. A pair of substrates 1 are opposed so as to be substantially in parallel to each other. An electrode 2 and an alignment film 3 are formed as layers on an opposed surface side of each of the substrates 1. Nematic liquid crystal molecules 4 are sandwiched between the substrates 1. The nematic liquid crystal molecules 4 are aligned in a predetermined direction by fine grooves formed in the alignment film 3. A polarizing plate 5 is provided on an upper surface of the substrates 1 in the drawing sheet. When no voltage is applied, the state is stable either in a state illustrated in part (h) of FIG. 2 or in a state illustrated in part (j) of FIG. 2.

By applying a voltage having a predetermined waveform to the nematic liquid crystal, the stable state of the orientation of the nematic liquid crystal molecules 4 is broken to raise the nematic liquid crystal molecules in a longitudinal direction (see the schematic view of part (g) of FIG. 2). After that, the voltage is suddenly lowered to a voltage having a level of 0 which is a reference voltage. Then, the orientation of the nematic liquid crystal molecules 4 is in a twisted state (see the schematic view of part (h) of FIG. 2).

Further, by applying a voltage having a predetermined waveform to the nematic liquid crystal, the stable state of the orientation of the nematic liquid crystal molecules 4 is broken to raise the nematic liquid crystal molecules 4 in the longitudinal direction (see a schematic view of part (i) of FIG. 2). After that, the voltage is gradually lowered over time to the voltage having the level of 0. Then, the orientation of the nematic liquid crystal molecules 4 is in a uniform state in which the nematic liquid crystal molecules 4 are substantially in parallel to one another (see the schematic view of part (j) of FIG. 2).

The two states, i.e., the twisted state and the uniform state are very stable, and the nematic liquid crystal molecules 4 have a feature that the two states are maintained without any further continuous voltage application or without any further periodical voltage application.

A notable point is that optical properties of the two states are different from each other, and hence, desired two states such as white/black may be created. By using the characteristics to arrange the nematic liquid crystal in matrix and to drive the nematic liquid crystal, a liquid crystal display panel may be materialized which may, after an image is written thereon, maintain the image in a predetermined state without power consumption. The liquid crystal display panel is referred to as a bistable liquid crystal display panel or a dot matrix display panel using bistable nematic liquid crystal. Further, for the sake of convenience, the following description is made on the precondition that white is displayed when the nematic liquid crystal molecules 4 are in the twisted state while black is displayed when the nematic liquid crystal molecules 4 are in the uniform state. However, the white display or the black display depends on the direction of the polarizing plate 5 which is provided, and thus, it is reasonably possible to display black in the twisted state and to display white in the uniform state. Further, combinations of two colors other than white or black are also possible as a matter of course.

However, when rewriting is performed continually at intervals of several seconds in a conventional method of driving a bistable liquid crystal display panel, a phenomenon occurs in which a “blur” is caused on a panel surface and the display can not be performed. In particular, the phenomenon described above occurs prominently in a bistable liquid crystal display panel that is subjected to ultraviolet irradiation for the purpose of improving voltage characteristics.

As another conventional method for solving the “blur”, a method is known in which a pixel write signal and a pixel erase signal are formed so as to have a symmetrical positive/negative voltage waveforms (see, for example, Patent Literature 1). Such a structure enables complete canceling of a parasitic signal. However, if a selection waveform is symmetrical, there is a problem that performance of rewriting on the bistable nematic liquid crystal display panel is reduced.

As illustrated in FIG. 15, a symmetrical selection waveform inputs white or black with a combination of a positive waveform and a negative waveform. While positive polarity driving 51 with a positive waveform requires a high voltage in writing, negative polarity driving 52 with a negative waveform may perform writing with a lower voltage.

In a graph of FIG. 16 in which the vertical axis denotes a light transmittance while the horizontal axis denotes a drive voltage, a characteristic curve of the positive polarity driving is shown by the broken line and a characteristic curve of the negative polarity driving is shown by the solid line. In the positive polarity driving shown by the broken line, the liquid crystal molecules are in the twisted state in a voltage range denoted as 53 in which the light transmittance is low. On the other hand, the liquid crystal molecules are in the uniform state in a voltage range denoted as 54 in which the light transmittance is high.

Similarly, in the negative polarity driving shown by the solid line, the liquid crystal molecules are in the twisted state in a voltage range denoted as 55 in which the light transmittance is low. On the other hand, the liquid crystal molecules are in the uniform state in a voltage range denoted as 56 in which the light transmittance is high.

When the driving is performed with a symmetrical selection waveform, a range between a threshold value Vp of the positive polarity driving and a threshold value Vm of the negative polarity driving is a mixed range 57 between the uniform state and the twisted state shown as a range between Vp and Vm. More specifically, in the mixed range 57, the absolute value of a drive voltage Vx is smaller than the absolute value of the threshold value Vp of the positive polarity driving, and, on the negative polarity side, is larger than the absolute value of the threshold value Vm of the negative polarity driving. Therefore, when the driving is performed with a symmetrical selection waveform, the optical properties of a liquid crystal pixel with respect to a drive voltage in the positive polarity driving differ from those in the negative polarity driving. The state varies with respect to respective intersection pixels, and thus, there is a problem that the display quality greatly varies over the whole surface of the liquid crystal panel. In other words, there is a problem that the performance of rewriting on the bistable nematic liquid crystal display panel is low.

### CITATION LIST

### Patent Literature

Patent Literature 1: JP 2004-4552 A

### SUMMARY OF INVENTION

### Technical Problem

Pursuit of the cause of the “blur” revealed that there were the following two problems.

One problem is that part of the alignment film is decomposed by ultraviolet irradiation to increase negative ions in the liquid crystal. The other problem is that, when the driving is performed with a drive waveform which contains a lot of direct current component that is caused because the voltage waveform is not symmetrical, the alignment film is decomposed to be ultimately broken.

Accordingly, a problem to be solved by the present invention is to solve the above two problems in a method and a device for driving a dot matrix display panel using bistable nematic liquid crystal and to prevent a “blur” due to a parasitic signal from being caused without impairing the performance of rewriting.

### Solution to Problem

In order to solve the above problem, in a method of driving a dot matrix display panel using bistable nematic liquid crystal which may select white/black only by positive polarity driving or negative polarity driving, a cancel pulse having a polarity that is opposite to that of a parasitic signal is applied between a selection waveform and the subsequent selection waveform so that a direct current component due to the parasitic signal is canceled.

Specific aspects of the present invention are described in the following.

A first invention relates to a method of driving a dot matrix display panel using bistable nematic liquid crystal, the dot matrix display panel using bistable nematic liquid crystal including: a pair of substrates opposed substantially in parallel to each other; a plurality of common electrodes and a plurality of segment electrodes which are formed in matrix on surfaces on opposed surface sides of the pair of substrates, respectively; alignment films formed on the plurality of common electrodes and the plurality of segment electrodes; nematic liquid crystal molecules which are sandwiched by the alignment films, have two stable orientation states, and are bistable so that the two stable orientation states are maintained even when no electric field is applied; and at least one polarizing plate provided outside the nematic liquid crystal molecules, the method including: applying any one of a selection signal for rewriting the nematic liquid crystal molecules and a non-selection signal from a common driving section, which is connected to the plurality of common electrodes, to the nematic liquid crystal molecules; selectively applying a signal for selecting one of the two stable orientation states from a segment driving section, which is connected to the plurality of segment electrodes, to the nematic liquid crystal molecules; and displaying an image based on common-segment voltages corresponding to electric fields between the plurality of common electrodes and the plurality of segment electrodes, in which the method further includes, in order to cancel a parasitic signal caused by application of the non-selection signal from the common driving section and the signal from the segment driving section to the nematic liquid crystal molecules, applying a cancel pulse having an amount of charge that is substantially equal to that of the parasitic signal and a polarity that is opposite to that of the parasitic signal from the common driving section or the segment driving section during a period between input of a signal and the subsequent input of a signal to the nematic liquid crystal molecules.

According to a second invention, in the first invention, the cancel pulse has an amplitude and a pulse width that are substantially equal to those of the parasitic signal on the common-segment voltages.

According to a third invention, in the first or second invention, an amount of charge accumulated from the plurality of common electrodes in the nematic liquid crystal molecules and an amount of charge accumulated from the plurality of segment electrodes in the nematic liquid crystal molecules are different from each other.

A fourth invention relates to a device for driving a dot matrix display panel using bistable nematic liquid crystal, the dot matrix display panel using bistable nematic liquid crystal including: a pair of substrates opposed substantially in parallel to each other; a plurality of common electrodes and a plurality of segment electrodes which are formed in matrix on surfaces on opposed surface sides of the pair of substrates, respectively; alignment films formed on the plurality of common electrodes and the plurality of segment electrodes; nematic liquid crystal molecules which are sandwiched by the alignment films, have two stable orientation states, and are bistable so that the two stable orientation states are maintained even when no electric field is applied; and at least one polarizing plate provided outside the nematic liquid crystal molecules, the device including: a common driving section connected to the plurality of common electrodes; a segment driving section connected to the plurality of segment electrodes; and a control section for controlling a power supply circuit, for controlling application of any one of a selection signal for rewriting the nematic liquid crystal molecules and a non-selection signal from the common driving section connected to the plurality of common electrodes to the nematic liquid crystal molecules, and for controlling selective application of a signal for selecting one of the two stable orientation states from the segment driving section connected to the plurality of segment electrodes to the nematic liquid crystal molecules, the device causing an image to be displayed based on common-segment voltages corresponding to electric fields between the plurality of common electrodes and the plurality of segment electrodes, in which the control section applies, in order to cancel a parasitic signal caused by application of the non-selection signal from the common driving section and the signal from the segment driving section to the nematic liquid crystal molecules, a cancel pulse having an amount of charge that is substantially equal to that of the parasitic signal and a polarity that is opposite to that of the parasitic signal from the common driving section or the segment driving section during a period between input of a signal and the subsequent input of a signal to the nematic liquid crystal molecules.

According to a fifth invention, in the fourth invention, the cancel pulse has an amplitude and a pulse width that are substantially equal to those of the parasitic signal on the common-segment voltages.

According to a sixth invention, in the fourth or fifth invention, an amount of charge accumulated from the plurality of common electrodes in the nematic liquid crystal molecules and an amount of charge accumulated from the plurality of segment electrodes in the nematic liquid crystal molecules are different from each other.

### Advantageous Effects of Invention

According to the present invention, in a method and a device for driving a dot matrix display panel using bistable nematic liquid crystal, a “blur” due to a parasitic signal which appears at the time of non-selection may be prevented from being caused. Further, according to the present invention, a device for driving a dot matrix display panel using bistable nematic liquid crystal which operates so as to prevent a “blur” due to a parasitic signal from being caused may be provided without impairing the performance of rewriting the display and without significantly changing a conventional device for driving a dot matrix display panel using bistable nematic liquid crystal.

### BRIEF DESCRIPTION OF DRAWINGS

FIG. 1 is a general functional block diagram illustrating display control of a bistable liquid crystal display panel.

FIG. 2 is an explanatory diagram of switching of bistable liquid crystal which schematically illustrates white or black display by an intersection pixel in response to waveforms of voltages applied to a common terminal and a segment terminal, respectively, and to a waveform of a common-segment voltage.

FIG. 3 illustrates voltage waveforms applied to common terminals and a segment terminal, respectively, of a bistable liquid crystal display panel.

FIG. 4 illustrates waveforms of voltages between the common electrode and the segment electrode of the bistable liquid crystal display panel.

FIG. 5 is a schematic view of the bistable liquid crystal display panel.

FIG. 6 illustrates a method of driving a dot matrix display panel using bistable nematic liquid crystal and illustrates waveforms of a common voltage, a segment voltage, and a common-segment voltage in a driving mode (Mode-C).

FIG. 7 illustrates waveforms of the common voltage, the segment voltage, and the common-segment voltage of the bistable liquid crystal display panel when driven in Mode-A.

FIG. 8 illustrates waveforms of the common voltage, the segment voltage, and the common-segment voltage of the bistable liquid crystal display panel when driven in Mode-B.

FIG. 9 illustrates waveforms of the common voltage, the segment voltage, and the common-segment voltage of the bistable liquid crystal display panel when driven in Mode-C.

FIG. 10 illustrates waveforms of the common voltage, the segment voltage, and the common-segment voltage of the bistable liquid crystal display panel when driven in Mode-D.

FIG. 11 illustrates waveforms of the common voltage, the segment voltage, and the common-segment voltage of the bistable liquid crystal display panel when driven in a driving mode E (Mode-E).

FIG. 12 illustrates waveforms of the common voltage, the segment voltage, and the common-segment voltage of the bistable liquid crystal display panel when driven in the driving mode E according to an embodiment of the present invention.

FIG. 13 illustrates a waveform of the common-segment voltage of the bistable liquid crystal display panel when driven in a conventional driving mode E.

FIG. 14 illustrates a waveform of the common-segment voltage of the bistable liquid crystal display panel when driven in the driving mode E of the embodiment according to the present invention.

FIG. 15 illustrates a waveform when the driving is performed with a driving signal having a conventional symmetrical selection waveform.

FIG. 16 illustrates optical properties of a liquid crystal pixel with respect to drive voltages in positive polarity driving and in negative polarity driving, respectively, when the liquid crystal pixel is driven with a driving signal having a conventional symmetrical selection waveform.

### DESCRIPTION OF EMBODIMENT

A method and a device for driving a bistable liquid crystal display panel according to the present invention may be implemented by partially changing a conventional driving method without changing hardware of the device for driving a bistable liquid crystal display panel.

Before an embodiment of the present invention is described, a structure of a bistable liquid crystal display panel is described.

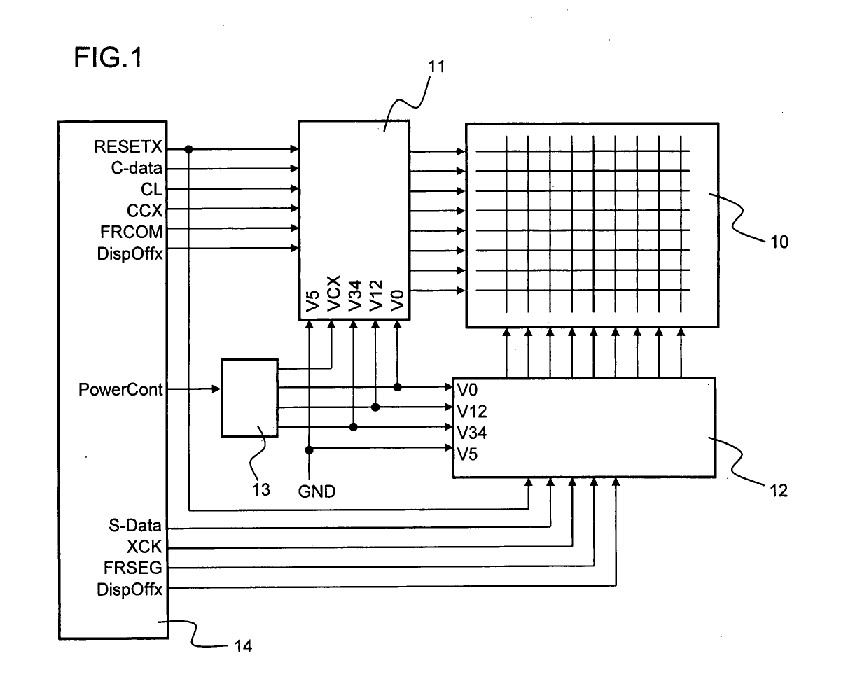

FIG. 1 is a general functional block diagram illustrating a display control of a bistable liquid crystal display panel 10. The bistable liquid crystal display panel 10 is driven by a driving device which includes a common driving section 11 for driving common lines in a lateral direction, a segment driving section 12 for driving segment lines in a longitudinal direction, a power supply circuit 13 for generating driving potentials (V0, V12, V34, V5, and VCX), and a control section 14 for controlling the common driving section 11, the segment driving section 12, and the power supply circuit 13.

Signals and functions for controlling the common driving section 11 and the segment driving section 12 by the control section 14 are the same as those of a normal STN driving circuit. An initialization signal RESETX, C-Data and a writing clock CL for determining a scan timing, an alternating current signal FRCOM, DispOffx for display erasing, and CCX are set for the common driving section 11. The initialization signal RESETX, S-Data and a writing clock XCK for providing display image data, an alternating current signal FRSEG, and DispOffx for display erasing are set for the segment driving section 12. As a matter of course, the power supply circuit 13 may be incorporated in the common driving section 11 or the segment driving section 12 may be further incorporated therein, to thereby serve as a single IC.

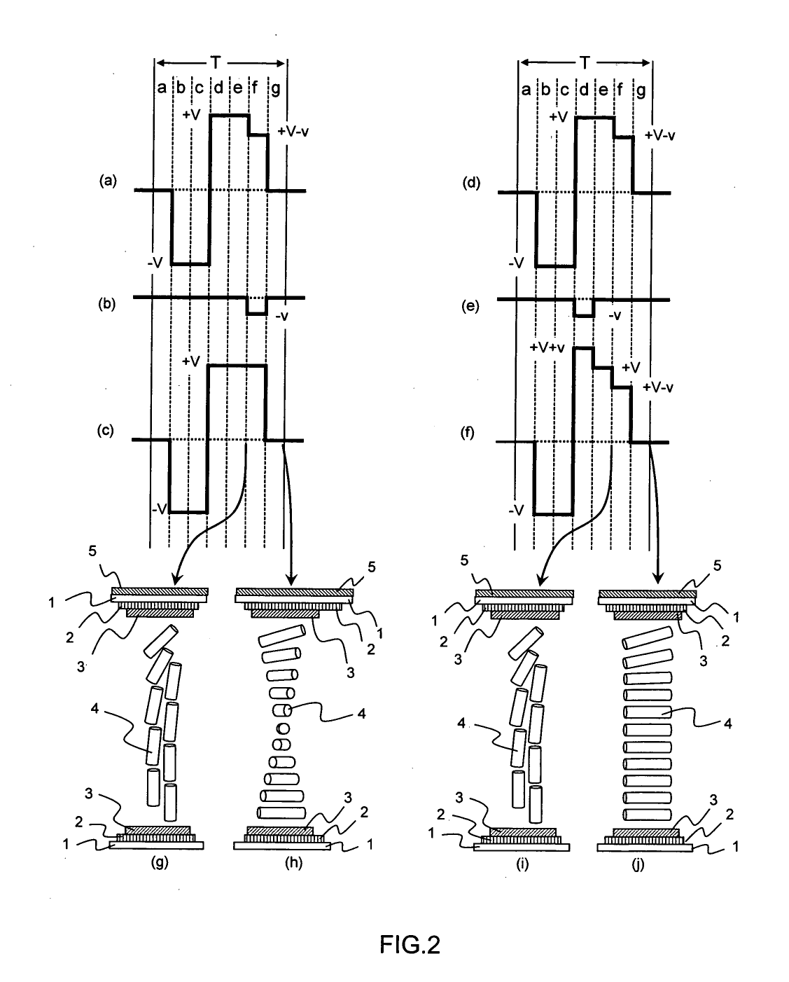

FIG. 2 is an explanatory diagram illustrating switching between states of a bistable nematic liquid crystal. A pair of substrates 1 are disposed so as to be opposed substantially parallel to each other. An electrode 2 and an alignment film 3 are formed as layers on an opposed surface side of each of the substrates 1. Nematic liquid crystal molecules 4 are sandwiched by the substrates 1. The nematic liquid crystal molecules 4 are aligned in a predetermined direction by fine grooves formed in the alignment films 3. A polarizing plate 5 is provided outside the substrate 1 located on the upper side of the sheet. A case is illustrated where specific signals are applied to common and segment electrodes of the bistable liquid crystal display panel 10 to switch a twisted direction of the nematic liquid crystal molecules between two kinds of states which are a twisted state and a uniform state. There are two kinds of write signals: a white write signal; and a black write signal. Further, there are two kinds of display signals: a white display voltage and a black display voltage.

First, a case where white is displayed on an intersection pixel between the common electrode and the segment electrode in the bistable liquid crystal display panel 10 is described. In part (a) of FIG. 2, a voltage waveform of a selection signal applied to a common terminal is a waveform which has a level of 0 for a first time interval “a” of a selection period T, a negative level −V for time intervals “b” and “c”, a positive level +V for subsequent time intervals “d” and “e”, a positive level +V−v for a subsequent time interval “f”, and the level of 0 for a remaining time interval “g”.

As illustrated in part (b) of FIG. 2, a voltage waveform of the white write signal applied to a segment terminal is a waveform which has the level of 0 for the first time interval “a” to the time interval “e” of the selection period T, a negative level −v for the subsequent time interval “f”, and the level of 0 for the remaining time interval “g”.

When the selection signal and the white write signal which are changed with time are applied as described above, a waveform of the white display voltage which is a voltage difference between the common terminal and the segment terminal becomes a waveform changed with time. That is, as illustrated in part (c) of FIG. 2, the waveform of the white display voltage is a waveform which has the level of 0 for the first time interval “a” of the selection period T, the negative level −V for the subsequent time intervals “b” and “c”, the positive level +V for the subsequent time intervals “d” and “e”, and the level of 0 for the remaining time interval “g”. Therefore, the waveform of the white display voltage is changed between the negative level −V and the positive level +V.

The reason why the white display voltage having the waveform as described above is applied to the nematic liquid crystal is as follows. First, a stable state of an orientation of the nematic liquid crystal molecules is broken by the voltage having the negative level −V to raise the nematic liquid crystal molecules 4 in a longitudinal direction (schematic view of part (g) of FIG. 2). After that, the voltage having the positive level +V is lowered to the voltage having the level of 0 to lay the nematic liquid crystal molecules 4 in an alignment direction (schematic view of part (h) of FIG. 2), to thereby set the twist state. Therefore, the white is displayed on the intersection pixel of the bistable liquid crystal display panel 10 which is applied with the white display voltage having the waveform illustrated in part (c) of FIG. 2.

Next, a case where black is displayed on the intersection pixel between the common electrode and the segment electrode in the bistable liquid crystal display panel 10 is described. The voltage waveform of the selection signal applied to the common terminal is identical to the waveform illustrated in part (a) of FIG. 2.

As illustrated in part (e) of FIG. 2, a voltage waveform of the black write signal is a waveform which has the level of 0 for the first time interval “a” to the time interval “c” of the selection period T, the negative level −v for the subsequent time interval “d”, and the level of 0 for remaining time intervals “e” to “g”.

When the selection signal and the black write signal which are changed with time are applied as described above, a waveform of the black display voltage which is a voltage difference between the common terminal and the segment terminal becomes a waveform changed with time. That is, as illustrated in part (f) of FIG. 2, the waveform of the black display voltage is a waveform which has the level of 0 for the first time interval “a” of the selection period T, the negative level −V for the subsequent time intervals “b” and “c”, a positive level +(V+v) for the subsequent time interval “d”, the positive level +V for the subsequent time interval “e”, the positive level +V−v for the subsequent time interval “f”, and the level of 0 for the remaining time interval “g”. Therefore, the voltage of the black display voltage is changed between −V and +(V+v).

The reason why the black display voltage having the waveform as described above is applied to the nematic liquid crystal is as follows. First, a stable state of the orientation of the nematic liquid crystal molecules is broken by the voltage having the negative level −V to raise the nematic liquid crystal molecules 4 in the longitudinal direction (see schematic view of part (i) of FIG. 2). After that, the positive level +(V+v) is reduced to the positive level +V, the positive level +V is reduced to the positive level +V−v, and at the end, the positive level +V−v is reduced to the level of 0. The stepwise reduction described above is performed to align the nematic liquid crystal molecules 4 in a substantially parallel manner (see schematic view of part (j) of FIG. 2), to thereby set the uniform state. Therefore, the black is displayed on the intersection pixel of the bistable liquid crystal display panel 10 which is applied with the black display voltage illustrated in part (f) of FIG. 2.

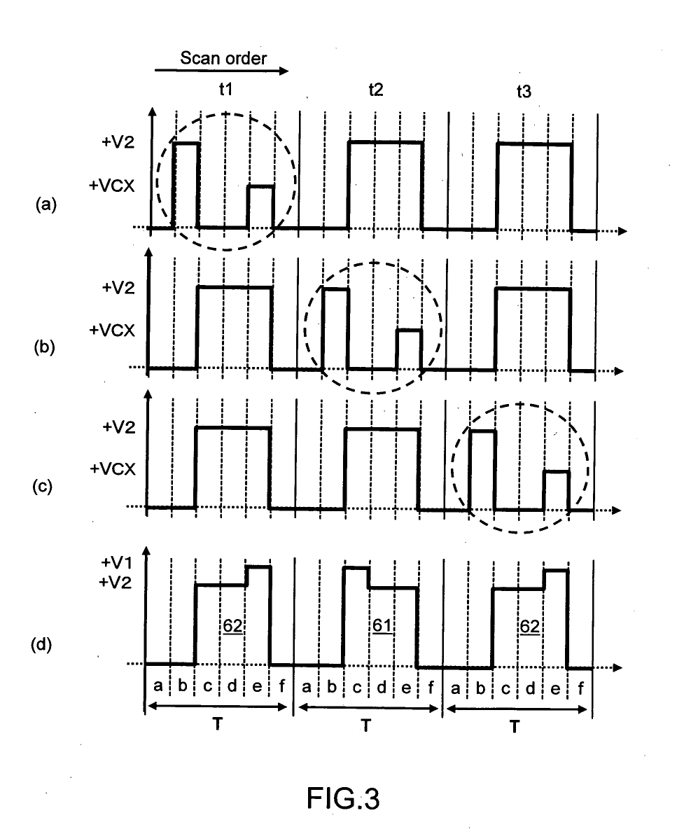

FIG. 3 illustrates exemplary voltage waveforms applied to the common terminals and the segment terminal, respectively, of the bistable liquid crystal display panel 10. Part (a) of FIG. 3 illustrates a waveform applied to an n-th row common terminal COM[n], part (b) of FIG. 3 illustrates a waveform applied to an (n+1)th row common terminal COM[n+1], part (c) of FIG. 3 illustrates a waveform applied to an (n+2)th row common terminal COM[n+2], part (d) of FIG. 3 illustrates a waveform applied to a segment terminal which intersects the three rows in succession, that is, an m-th column segment terminal SEG[m].

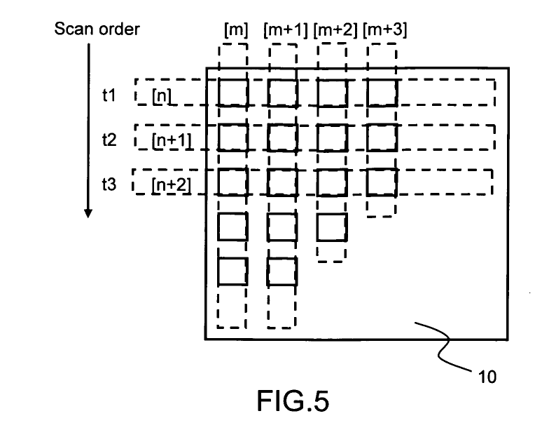

Further, FIG. 5 illustrates voltage waveforms with the passage of time applied to the common terminals COM[n], COM[n+1], and COM[n+2] in the three rows in succession and to the m-th column segment terminal SEG[m] and the segment terminals SEG[m+1], SEG[m+2], and SEG[m+3] which intersect the common terminals of the bistable liquid crystal display panel 10. Note that, portions encircled by the broken lines are voltage waveforms of selection signals.

A voltage waveform of the selection signal applied to each of the common terminals at the time of selection is illustrated in a portion encircled by the broken line in each of part (a) to part (c) of FIG. 3 and is a waveform which has the level of 0 for the first time interval “a” of the selection period T, a positive level +V2 for the subsequent time interval “b”, the level of 0 for subsequent time intervals “c” and “d”, a level VCX for the time interval “e”, and the level of 0 for a remaining time interval “f”. Note that, V2>VCX.

A voltage waveform of a non-selection signal applied to each of the common terminals at the time of non-selection is illustrated in each of part (a) to part (c) of FIG. 3 and is a waveform which has the level of 0 for the first time interval “a” and the time interval “b” of the selection period T, the positive level +V2 for the subsequent time intervals “c” to “e”, and the level of 0 for the remaining time interval “f”.

The voltage waveform of the signal applied to the common terminal is significantly different between FIGS. 2 and 3. That is, the voltage waveform of the selection signal illustrated in FIG. 2 is a voltage waveform significantly changed to the positive and negative sides, but the voltage waveform of the selection signal illustrated in FIG. 3 is a waveform significantly changed to only the positive side. Note that, the non-selection signal illustrated in FIG. 3 also has a waveform significantly changed to only the positive side.

As illustrated in part (a) of FIG. 3, the n-th row common terminal COM[n] is applied with the selection signal for a scan time section t1 and the non-selection signals for scan time sections t2 and t3. As illustrated in part (b) of FIG. 3, the subsequent (n+1)-th row common terminal COM[n+1] is applied with the non-selection signal for the scan time section t1, the selection signal for the scan time section t2, and the non-selection signal for the scan time section t3. As illustrated in part (c) of FIG. 3, the subsequent (n+2)-th row common terminal COM[n+2] is applied with the non-selection signals for the scan time sections t1 and t2 and the selection signal for the scan time section t3.

Voltage waveforms of segment voltages, that is, a white write signal 62 and a black write signal 61, which are applied to the segment terminal SEG[m], are illustrated in part (d) of FIG. 3. In this case, the white write signal 62 is applied for the scan time section t1, the black write signal 61 is applied for the scan time section t2, and the white write signal 62 is applied for the scan time section t3. Here, V1>V2.

The voltage waveform of the white write signal is a waveform which has the level of 0 for the first time interval “a” and the time interval “b” of the selection period T, the positive level +V2 for the subsequent time intervals “c” and “d”, a positive level +V1 for the subsequent time interval “e”, and the level of 0 for the remaining time interval “f”.

Further, the voltage waveform of the black write signal is a waveform which has the level of 0 for the first time interval “a” and the time interval “b” of the selection period T, the positive level +V1 for the subsequent time interval “c”, the positive level +V2 for the subsequent time intervals “d” and “e”, and the level of 0 for the remaining time interval “f”.

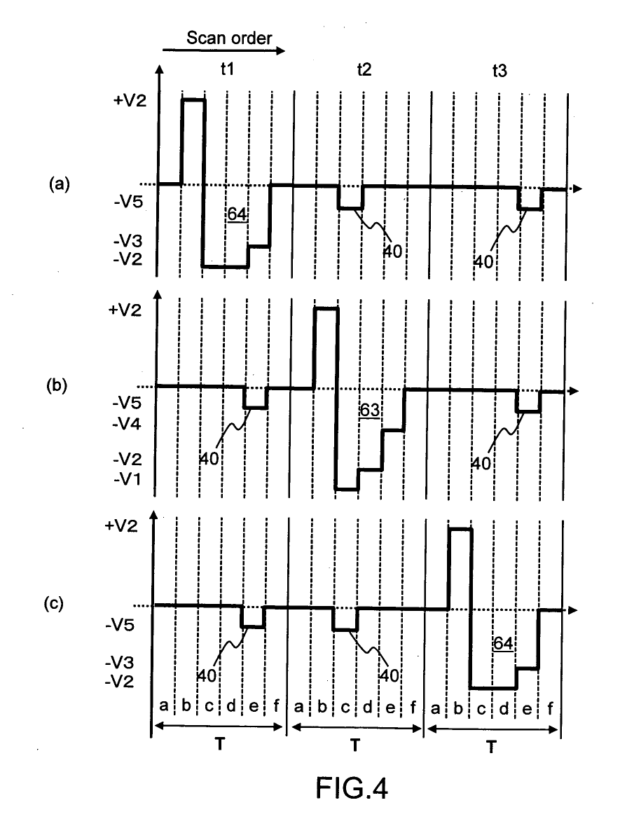

When the selection signal or the non-selection signal is applied to the common terminals and the white write signal or the black write signal is applied to the segment terminal as described above, common-segment voltages between the common terminals and the segment terminal, that is, the white display voltage and the black display voltage, as illustrated in parts (a) to (c) of FIG. 4, are obtained.

As illustrated in part (a) of FIG. 4, an intersection pixel between the n-th row common terminal COM[n] and the m-th column segment terminal SEG[m] in the scan time section t1 is applied with a white display voltage 64 of a waveform which has the level of 0 for the first time interval “a” of the selection period T, the positive level +V2 for the subsequent time interval “b”, a negative level −V2 for the subsequent time intervals “c” and “d”, a negative level −V3 for the subsequent time interval “e”, and the level of 0 for the remaining time interval “f”.

In the scan time section t2, the voltage waveform has the level of 0 for the first time intervals “a” and “b” of the selection period T, a negative level −V5 for the subsequent time interval “c”, and the level of 0 for the remaining time intervals “d” to “f”. Here, a first parasitic signal 40 of the voltage waveform is applied. Further, in the scan time section t3, a second parasitic signal 40 is applied having the voltage waveform of which has the level of 0 for the first time intervals “a” to “d” of the selection period T, the negative level −V5 for the subsequent time interval “e”, and the level of 0 for the remaining time interval “f”.

Next, as illustrated in part (b) of FIG. 4, an intersection pixel between the (n+1)-th row common terminal COM[n+1] and the m-th column segment terminal SEG[m] is applied with the second parasitic signal 40 in the scan time section t1, a black display voltage 63 in the scan time section t2, and the first parasitic signal 40 in the scan time section t3. The black display voltage 63 is a voltage of a waveform which has the level of 0 for the first time interval “a” of the selection period T, the positive level +V2 for the subsequent time interval “b”, the negative level −V1 for the subsequent time interval “c”, the negative level −V2 for the subsequent time interval “d”, a negative level −V4 for the subsequent time interval “e”, and the level of 0 for the remaining time interval “f”.

Further, as illustrated in part (c) of FIG. 4, an intersection pixel between the (n+2)-th row common terminal COM[n+1] and the m-th column segment terminal SEG[m] is applied with the first parasitic signal 40 in the scan time section t1, the second parasitic signal 40 in the scan time section t2, and the white display voltage 64 in the scan time section t3. The voltage waveform of the white display voltage 64 has the level of 0 for the first time interval “a” of the selection period T, the positive level +V2 for the subsequent time interval “b”, the negative level −V2 for the subsequent time intervals “c” and “d”, the negative level −V3 for the subsequent time interval “e”, and the level of 0 for the remaining time interval “f”.

As described above, with regard to display on the bistable liquid crystal display panel 10, white/black for one line is determined by signal states of one common which outputs a voltage waveform of a selection signal and of all the segments. By scanning in sequence all the commons for one frame, display for the whole frame is determined. Only one common of the whole frame is scanned at a moment, and the remaining majority of commons output a voltage waveform of a non-selection signal. When the amount of charge which is charged or discharged in the bistable liquid crystal display panel is considered, it is necessary to focus on a potential difference between the voltage of the non-selection signal which is output by the majority of the commons and the voltage of the white write signal or the black write signal applied to the segment terminals. More specifically, the parasitic signal in the waveform of the common-segment voltage between the common terminal and the segment terminal greatly contributes to the amount of charge which is charged or discharged in driving the bistable liquid crystal display panel 10 to thereby affect the amount of current consumption.

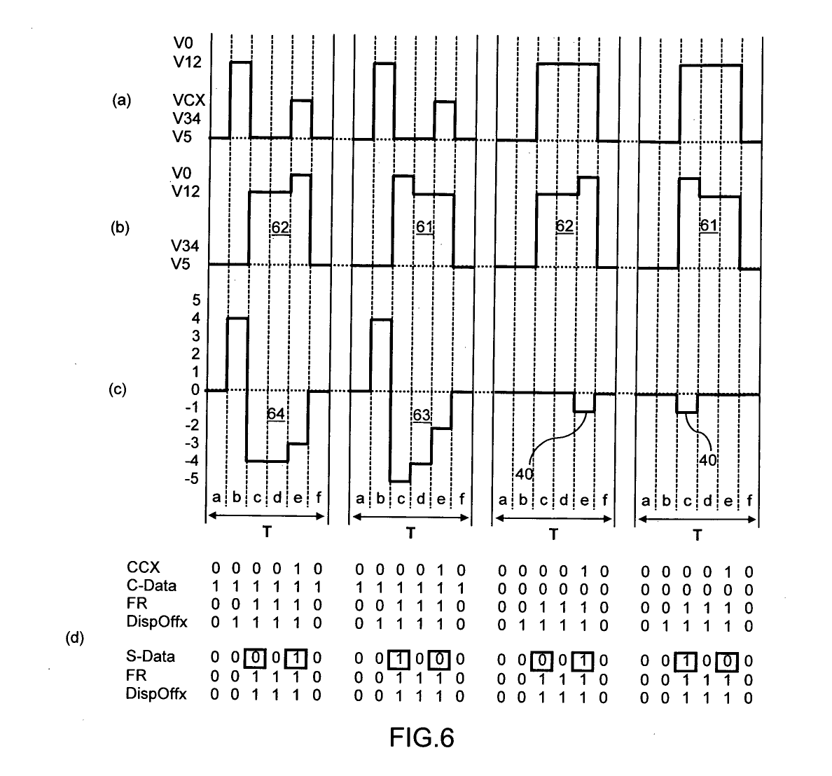

FIG. 6 illustrates waveforms in a specific driving mode (Mode-C) of the bistable liquid crystal display panel. Four kinds of waveforms applied to the bistable liquid crystal display panel are: the selection signal applied to the common terminal at the time of selection; the non-selection signal applied to the common terminal at the time of non-selection; the white write signal 62 applied to the segment terminal; and the black write signal 61 applied to the segment terminal. Their voltage waveforms are the same as those illustrated in FIG. 3. Part (a) of FIG. 6 illustrates a waveform applied to the common terminal, part (b) of FIG. 6 illustrates a waveform applied to the segment terminal, part (c) of FIG. 6 illustrates a waveform of the common-segment voltage, and part (d) of FIG. 6 illustrates a signal which is output from an MPU to the segment driving section or the common driving section.

FIG. 6 also illustrates four kinds of voltages applied to the intersection pixel of the common terminal and the segment terminal, that is, the white display voltage 64, the black display voltage 63, the first parasitic signal, and the second parasitic signal. The parasitic signals are denoted as 40. Their voltage waveforms are the same as those illustrated in FIG. 4.

Numerals “1” and “0” illustrated in part (d) of FIG. 6 indicate control signals for the waveform of a common voltage applied to the common terminal and the waveform of a segment voltage applied to the segment terminal. The waveform of the common voltage is controlled based on four signals CCX, C-Data, FR, and DispOffx. The waveform of the segment voltage is controlled based on three signals S-Data, FR, and DispOffx. When a driver (not employing SA driving system) which is already commercially available and normally drives a general STN liquid crystal is used as a segment driving device, a truth table of an input and output table of a segment driver (SEG-Drv.) is shown as the following Table 1. The output voltage is controlled based on the three control signals, and hence the correspondences between the segment control signals and the segment voltage waveforms, as illustrated in FIG. 4, respectively, are established.

TABLE 1
TRUTH TABLE SEG-Drv.

| S-Data | FR | DispOffx | Output |
|---|---|---|---|
| 0 | 0 | 1 | V34 |
| 1 | 0 | 1 | V5 |
| 0 | 1 | 1 | V12 |
| 1 | 1 | 1 | V0 |
| X | X | 0 | V5 |

A common voltage waveform for driving the bistable liquid crystal display panel 10 has the potential VCX which does not appear during normal driving for the general STN liquid crystal, and hence a control signal for outputting the potential is expressed by CCX. Tables 2 and 3 given below are truth tables of an input and output table of a common driver (COM-Drv.). When common output control is performed as illustrated in the column of the driving mode (Mode-C), the correspondences between the common control signals and the common voltage waveforms illustrated in FIG. 6 are established.

TABLE 2
TRUTH TABLE COM-Drv.

| CCX | C-Data | FR | DispOffx |
|---|---|---|---|
| 0 | 0 | 0 | 1 |
| 0 | 1 | 0 | 1 |
| 0 | 0 | 1 | 1 |
| 0 | 1 | 1 | 1 |
| 1 | 0 | 0 | 1 |
| 1 | 1 | 0 | 1 |
| 1 | 0 | 1 | 1 |
| 1 | 1 | 1 | 1 |
| X | X | X | 0 |

TABLE 3

| Mode-A | Mode-B | Mode-C | Mode-D |
|---|---|---|---|
| V5 | V34 | V5 | V34 |
| V0 | V0 | V12 | V12 |
| V0 | V0 | V12 | V12 |
| V5 | V5 | V5 | V34 |
| V5 | V34 | don't care | don't care |
| VCX | VCX | don't care | don't care |
| don't care | don't care | V12 | V12 |
| don't care | don't care | VCX | VCX |
| V5 | V34 | V5 | V34 |

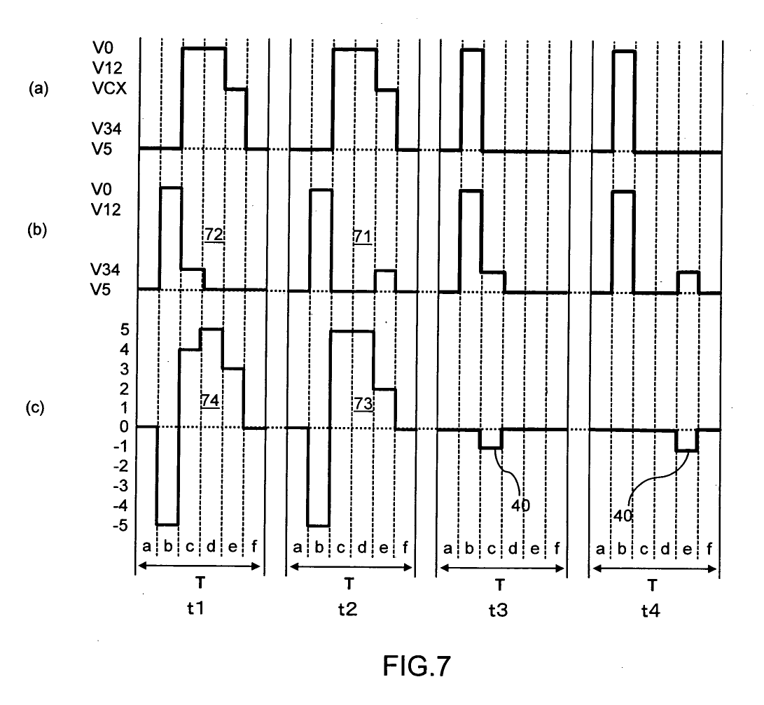

FIGS. 7 to 10 illustrate four driving modes (Mode-A, Mode-B, Mode-C, and Mode-D), respectively, of the bistable liquid crystal display panel 10 with four kinds of waveforms which exhibit characteristics of the respective modes similarly to the method of expressing the driving mode (Mode-C) of FIG. 6.

Further, through FIGS. 7 to 10, parts (a) illustrate voltage waveforms from the common terminal, parts (b) illustrate waveforms of segment signals, and parts (c) illustrate combined waveforms which are differences between the voltage waveforms from the common terminal and the voltage waveforms from the segment terminal. The horizontal axis is common to parts (a) to (c) in the respective figures. From the left side of each of the sheets of the drawings, a column denoted as t1 is when the selection signal is applied to the common terminal and the white write signal is applied to the segment terminal, a column denoted as t2 is when the selection signal is applied to the common terminal and the black write signal is applied to the segment terminal, a column denoted as t3 is when the non-selection signal is applied to the common terminal and the white write signal is applied to the segment signal, and a column denoted as t4 is when the non-selection signal is applied to the common terminal and the black write signal is applied to the segment signal.

More specifically, a waveform of a white display voltage 74 is in t1 in parts (c) throughout the figures while a waveform of a black display voltage 73 is in t2 in parts (c) throughout the figures.

When the driving is performed in the driving mode A (Mode-A) as illustrated in FIG. 7, the parasitic signal 40 which is a negative rectangular wave is generated in a time interval “c” of the selection period T at the intersection pixel of the common terminal to which the non-selection signal is applied and the segment terminal to which a white write signal 72 is applied. Further, the parasitic signal 40 which is a negative rectangular wave is generated in a time interval “e” of the selection period T at the intersection pixel of the common terminal to which the non-selection signal is applied and the segment terminal to which a black write signal 71 is applied.

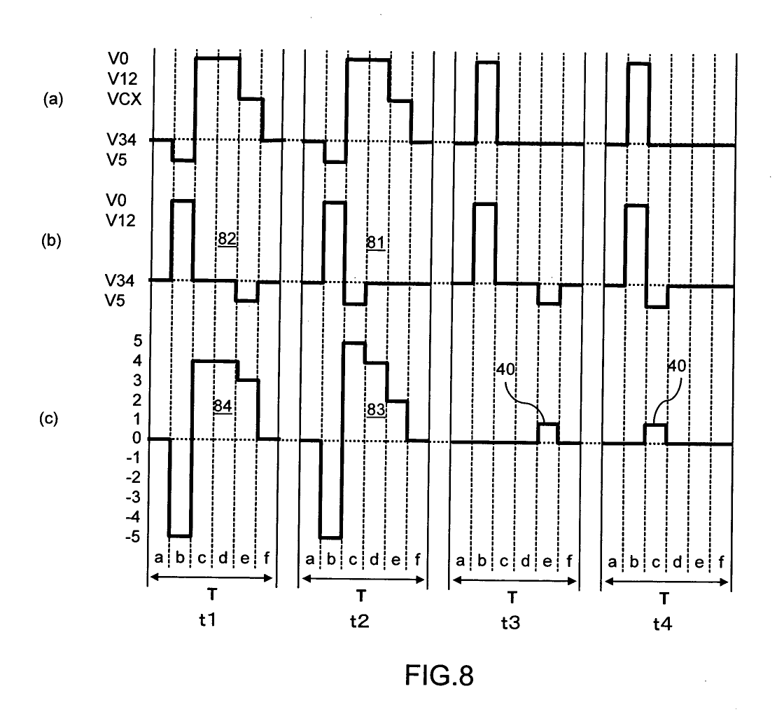

When the driving is performed in the driving mode B (Mode-B) as illustrated in FIG. 8, the parasitic signal 40 which is a positive rectangular wave is generated in a time interval “e” of the selection period T at the intersection pixel of the common terminal to which the non-selection signal is applied and the segment terminal to which a white write signal 82 is applied. Further, the parasitic signal 40 which is a positive rectangular wave is generated in a time interval “c” of the selection period T at the intersection pixel of the common terminal to which the non-selection signal is applied and the segment terminal to which a black write signal 81 is applied.

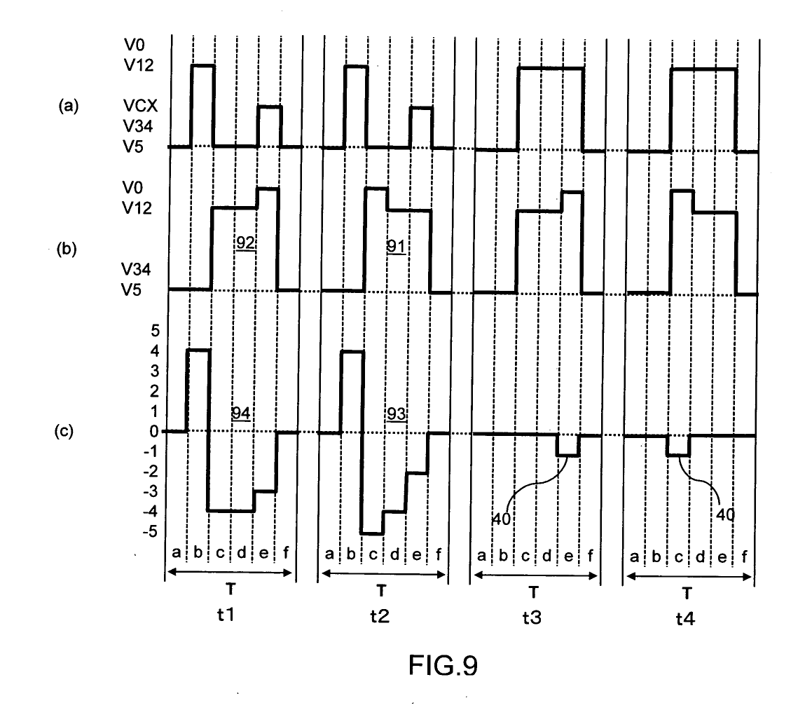

When the driving is performed in the driving mode C (Mode-C) as illustrated in FIG. 9, the parasitic signal 40 which is a negative rectangular wave is generated in a time interval “e” of the selection period T at the intersection pixel of the common terminal to which the non-selection signal is applied and the segment terminal to which a white write signal 92 is applied. Further, the parasitic signal 40 which is a negative rectangular wave is generated in a time interval “c” of the selection period T at the intersection pixel of the common terminal to which the non-selection signal is applied and the segment terminal to which a black write signal 91 is applied.

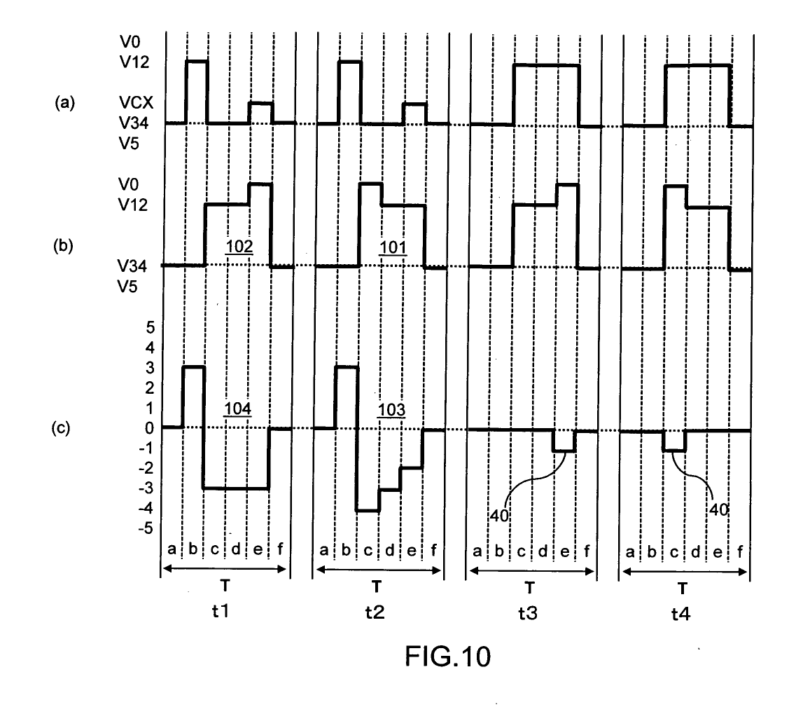

When the driving is performed in the driving mode D (Mode-D) as illustrated in FIG. 10, the parasitic signal 40 which is a negative rectangular wave is generated in a time interval “e” of the selection period T at the intersection pixel of the common terminal to which the non-selection signal is applied and the segment terminal to which a white write signal 102 is applied. Further, the parasitic signal 40 which is a negative rectangular wave is generated in a time interval “c” of the selection period T at the intersection pixel of the common terminal to which the non-selection signal is applied and the segment terminal to which a black write signal 101 is applied. This Mode-D is, differently from other modes, characterized in that the lowest value of the voltages of the common terminal and the segment terminal is not V5 but V34, which has the effect of making relatively narrower the combined common-segment waveform.

By providing the device for driving a dot matrix display panel using bistable nematic liquid crystal with the plurality of driving modes including the positive polarity driving modes (Mode-A and Mode-B) and the negative polarity driving modes (Mode-C and Mode-D), rational driving according to the characteristics of the bistable liquid crystal display panel is made possible.

The method of driving a dot matrix display panel using bistable nematic liquid crystal is described above. In the following embodiment, the method to which advantages of the present invention are added is described.

### Embodiment

A driving device to which a driving method according to the present invention is applied, that is, a device for driving a dot matrix display panel using bistable nematic liquid crystal which selects white/black only by positive polarity driving or negative polarity driving has the same hardware configuration as a conventional one.

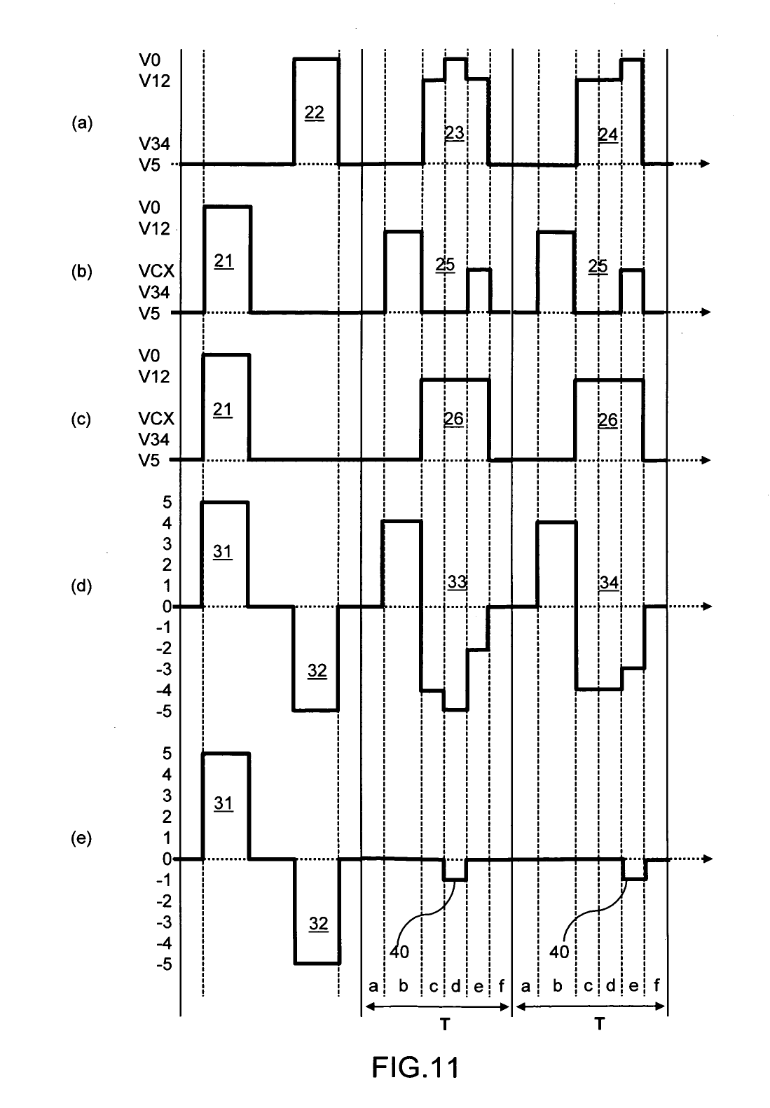

The method of driving a dot matrix display panel using bistable nematic liquid crystal is described with reference to FIGS. 11 to 14. For the sake of easy understanding, the method of driving a bistable liquid crystal display panel according to the present invention is described in contrast with a conventional driving method.

(Conventional Driving Method Involving Generation of Parasitic Signal)

FIG. 11 illustrates voltage waveforms of a dot matrix display panel using bistable nematic liquid crystal when driven in a conventional driving mode (Mode-E), which may select white/black only by positive polarity driving or negative polarity driving. Part (a) of FIG. 11 illustrates voltage waveforms of a black write signal 23 and a white write signal 24 applied to the segment terminal, part (b) of FIG. 11 illustrates a voltage waveform of a common selection signal 25 applied to the common terminal, part (c) of FIG. 11 illustrates a voltage waveform of a common non-selection signal 26 applied to the common terminal, part (d) of FIG. 11 illustrates voltage waveforms of a black display voltage 33 and a white display voltage 34 which are common-segment voltages at the time of selection, and part (e) of FIG. 11 illustrates a voltage waveform of the parasitic signal 40 which is a common-segment voltage at the time of non-selection.

As illustrated in part (a) of FIG. 11, the voltage waveform of the black write signal 23 has the positive level +V5 for the first time intervals “a” and “b” of the selection period T, the positive level +V12 for the subsequent time interval “c”, the positive level +V0 for the subsequent time interval “d”, the positive level +V12 for the subsequent time interval “e”, and the positive level +V5 for the remaining time interval “f”. Further, the time intervals are not equal to one another, but the time intervals have their respective lengths as illustrated in FIG. 11.

As illustrated in part (a) of FIG. 11, the voltage waveform of the white write signal 24 has the positive level +V5 for the first time intervals “a” and “b” of the selection period T, the positive level +V12 for the subsequent time intervals “c” and “d”, the positive level +V0 for the subsequent time interval “e”, and the positive level +V5 for the remaining time interval “f”.

As illustrated in part (b) of FIG. 11, the voltage waveform of the common selection signal 25 has the positive level +V5 for the first time interval “a” of the selection period T, the positive level +V12 for the subsequent time interval “b”, the positive level +V5 for the subsequent time intervals “c” and “d”, the positive level +VCX for the subsequent time interval “e”, and the positive level +V5 for the remaining time interval “f”.

As illustrated in part (c) of FIG. 11, the voltage waveform of the common non-selection signal 26 has the positive level +V5 for the first time intervals “a” and “b” of the selection period T, the positive level +V12 for the subsequent time intervals “c” to “e”, and the positive level +V5 for the remaining time interval “f”.

When the above-mentioned voltages are applied to the common terminal and the segment terminal at the time of selection, the common-segment voltage between the common terminal and the segment terminal is as illustrated in part (d) of FIG. 11. Note that, in part (d) of FIG. 11, an erase pulse 31 is a rectangular wave having a positive level +5, and a pulse 32 for erasing a direct current component of an erase pulse which is applied subsequently is a rectangular wave having a negative level −5.

The waveform of the black display voltage 33 when the common selection signal 25 and the black write signal 23 are applied has the level of 0 for the first time interval “a” of the selection period T, a positive level +4 for the subsequent time interval “b”, a negative level −4 for the subsequent time interval “c”, a negative level −5 for the subsequent time interval “d”, a negative level −2 for the subsequent time interval “e”, and a positive level +0 for the remaining time interval “f”.

Further, the waveform of the white display voltage 34 when the common selection signal 25 and the white write signal 24 are applied has the level of 0 for the first time interval “a” of the selection period T, a positive level +4 for the subsequent time interval “b”, a negative level −4 for the subsequent time intervals “c” and “d”, a negative level −3 for the subsequent time interval “e”, and the level of 0 for the remaining time interval “f”.

When the above-mentioned voltages are applied to the common terminal and the segment terminal at the time of non-selection, the common-segment voltage between the common terminal and the segment terminal is as illustrated in part (e) of FIG. 11. Note that, in part (e) of FIG. 11, an erase pulse 31 is a rectangular wave having a positive level +5, and a pulse 32 for erasing a direct current component of an erase pulse which is applied subsequently is a rectangular wave having a negative level −5. Further, the erase pulse 31 is derived from a signal 21 for generating an erase pulse. The pulse 32 for erasing a direct current component of an erase pulse is derived from a pulse 22 for canceling a direct current component of a signal for generating an erase pulse.

When the common non-selection signal 26 and the black write signal 23 are applied, the voltage waveform has the level of 0 for the first time intervals “a” to “c” of the selection period T, a negative level −1 for the subsequent time interval “d”, and the level of 0 for the remaining time intervals “e” and “f”. The rectangular wave pulse of the negative level −1 is the parasitic signal 40.

When the non-selection signal 26 and the white write signal 24 are applied, the voltage waveform has the level of 0 for the first time intervals “a” to “d” of the selection period T, a negative level −1 for the subsequent time interval “e”, and the level of 0 for the remaining time interval “f”. The rectangular wave pulse of the negative level −1 is the parasitic signal 40.

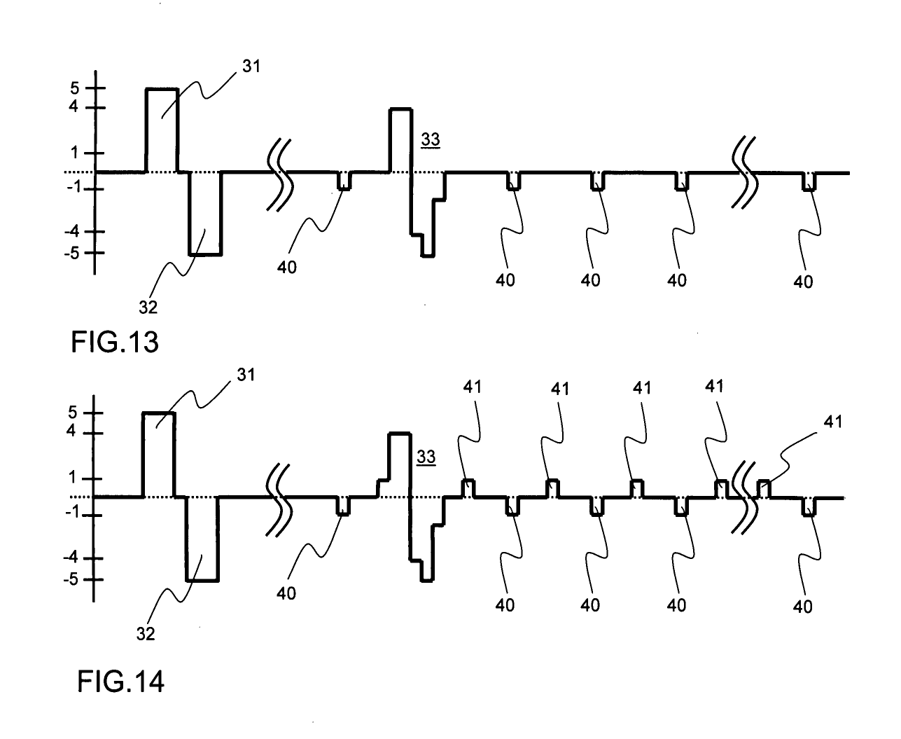

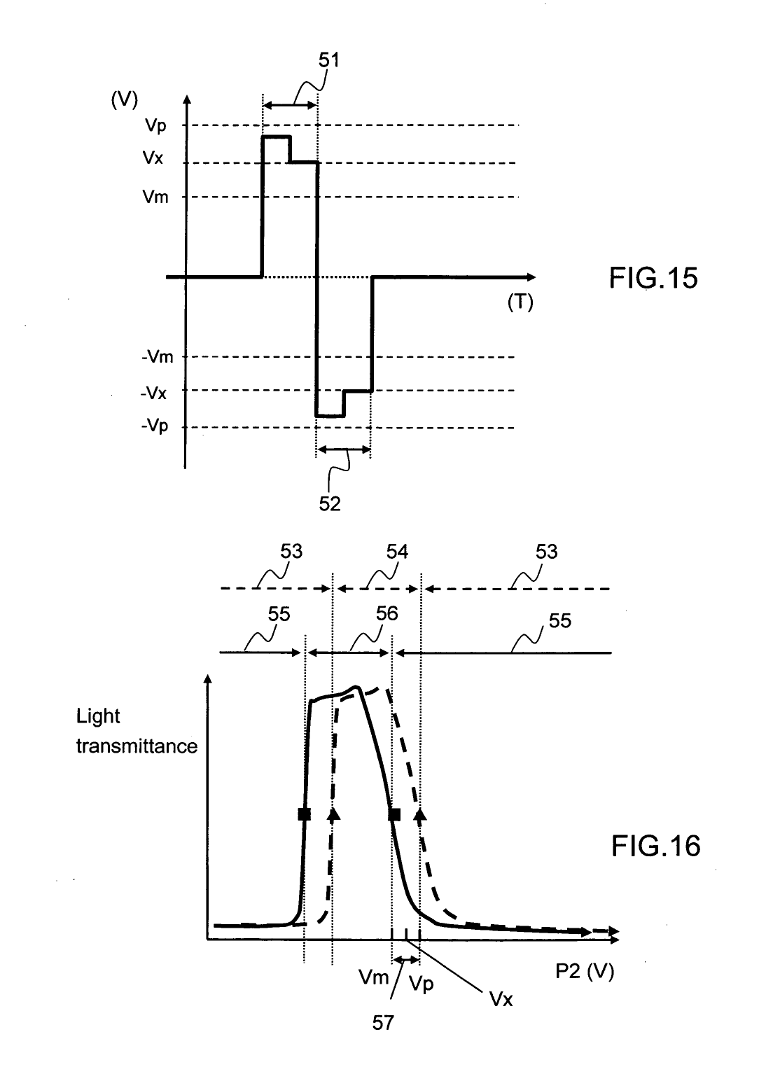

FIG. 13 illustrates a waveform of the common-segment voltage of the bistable liquid crystal display panel when driven in the conventional driving mode E illustrated in FIG. 11. As is clear from FIG. 13, when the bistable liquid crystal display panel 10 is driven in the conventional driving mode E, the parasitic signal 40 is applied to the whole surface of the panel at the time of non-selection. The parasitic signal 40 is a negative rectangular wave pulse having a small pulse width and a small amplitude. More specifically, the parasitic signal 40 is a rectangular wave pulse having a pulse width of 1.8 ms and an amplitude of 6.4 V. On the other hand, the black display voltage 33 which is the common-segment voltage at the time of selection is formed of a positive rectangular wave pulse having a pulse width of 4 ms and an amplitude of 14 V and a subsequent negative rectangular pulse having a similar pulse width and an amplitude which changes in a step-like manner. The erase pulse 31 is a positive rectangular wave pulse having a pulse width of 4 ms and an amplitude of 24 V, and the subsequent pulse 32 for canceling a direct current component is a negative rectangular wave pulse having a pulse width of 4 ms and an amplitude of 24 V.

The parasitic signal 40 has, as in this example, a pulse width and an amplitude which are considerably smaller than those of the black display voltage 33 which is the common-segment voltage at the time of selection. However, the parasitic signal 40 appears on the whole surface of the panel at the time of non-selection, and thus, when continuous driving is performed at room temperature for a long time, according to a result of an experiment, a “blur” is caused at a lower portion of the bistable liquid crystal display panel after a lapse of about 200 hours, which has such a significant effect that the display becomes impossible.

(Driving Method of Canceling Parasitic Signal)

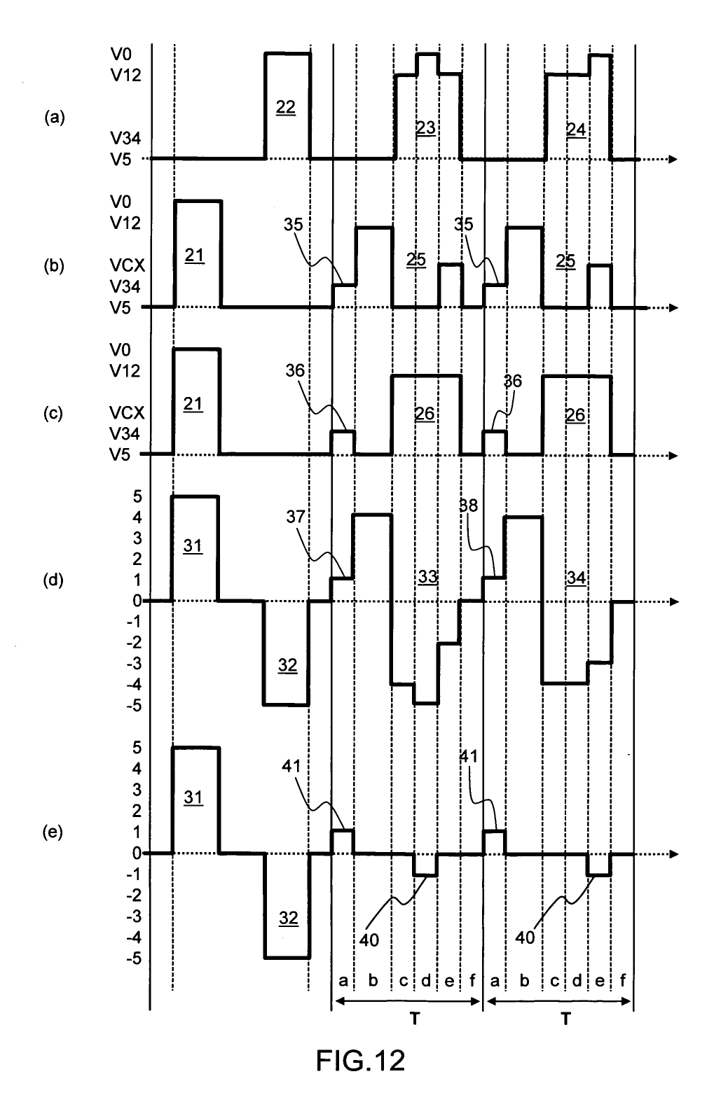

Next, a driving method of canceling the direct current component due to the parasitic signal 40 caused when the driving is performed in the driving mode E illustrated in FIG. 11 is described with reference to FIG. 12.

With reference to FIG. 12, as illustrated in part (a) of FIG. 12, the voltage waveform of the black write signal 23 has the positive level +V5 for the first time intervals “a” and “b” of the selection period T, the positive level +V12 for the subsequent time interval “c”, the positive level +V0 for the subsequent time interval “d”, the positive level +V12 for the subsequent time interval “e”, and the positive level +V5 for the remaining time interval “f”. This is the same as the voltage waveform of the black write signal 23 in the conventional driving mode E illustrated in FIG. 11.

As illustrated in part (a) of FIG. 12, the voltage waveform of the white write signal 24 has the positive level +V5 for the first time intervals “a” and “b” of the selection period T, the positive level +V12 for the subsequent time intervals “c” and “d”, the positive level +V0 for the subsequent time interval “e”, and the positive level +V5 for the remaining time interval “f”. This is the same as the voltage waveform of the white write signal 24 in the conventional driving mode E illustrated in FIG. 11.

As illustrated in part (b) of FIG. 12, the voltage waveform of the selection signal 25 applied to the common terminal at the time of selection has the positive level +V34 for the first time interval “a” of the selection period T, the positive level +V12 for the subsequent time interval “b”, the positive level +V5 for the subsequent time intervals “c” and “d”, the positive level +VCX for the subsequent time interval “e”, and the positive level +V5 for the remaining time interval “f”. This is different from the voltage waveform of the selection signal 25 in the conventional driving mode E illustrated in FIG. 11 in that an additive pulse 35 which is a rectangular wave is added.

As illustrated in part (c) of FIG. 12, the voltage waveform of the non-selection signal 26 applied to the common terminal at the time of non-selection has the positive level +V34 for the first time interval “a” of the selection period T, the positive level +V5 for the subsequent time interval “b”, the positive level +V12 for the subsequent time intervals “c” to “e”, and the positive level +V5 for the remaining time interval “f”. This is different from the voltage waveform of the non-selection signal 26 in the conventional driving mode E illustrated in FIG. 11 in that an additive pulse 36 which is a rectangular wave is added.

When the above-mentioned voltages are applied to the common terminal and the segment terminal at the time of selection, the common-segment voltage between the common terminal and the segment terminal is as illustrated in part (d) of FIG. 12. In part (d) of FIG. 12, the erase pulse 31 is a rectangular wave having the positive level +5, and the pulse 32 for erasing a direct current component of an erase pulse which is applied subsequently is a rectangular wave having the negative level −5. The pulse 32 for erasing a direct current component of an erase pulse which is applied subsequently is a rectangular wave having the negative level −5. These are the same as the voltage waveforms of the erase pulse 31 and the pulse 32 for erasing a direct current component of an erase pulse in the conventional driving mode E illustrated in FIG. 11.

The waveform of the black display voltage 33 when the selection signal 25 and the black write signal 23 are applied has a level +1 for the first time interval “a” of the selection period T, the positive level +4 for the subsequent time interval “b”, the negative level −4 for the subsequent time interval “c”, the negative level −5 for the subsequent time interval “d”, the negative level −2 for the subsequent time interval “e”, and the positive level +0 for the remaining time interval “f”. This is different from the black display voltage 33 in the conventional driving mode E illustrated in FIG. 11 in that a rectangular added portion 37 is added.

In addition, the waveform of the white display voltage 34 when the selection signal 25 and the white write signal 24 are applied has the positive level +1 for the first time interval “a” of the selection period T, the positive level +4 for the subsequent time interval “b”, the negative level −4 for the subsequent time intervals “c” and “d”, the negative level −3 for the subsequent time interval “e”, and the level of 0 for the remaining time interval “f”. This is different from the white display voltage 34 in the conventional driving mode E illustrated in FIG. 11 in that rectangular added portions 37 and 38 are added.

When the above-mentioned voltages are applied to the common terminal and the segment terminal at the time of non-selection, the common-segment voltage between the common terminal and the segment terminal is as illustrated in part (e) of FIG. 12. In part (e) of FIG. 12, the erase pulse 31 is a rectangular wave having the positive level +5, and the pulse 32 for erasing a direct current component of an erase pulse which is applied subsequently is a rectangular wave having the negative level −5. These are the same as the voltage waveforms of the erase pulse 31 and the cancel pulse 41 for erasing a direct current component of an erase pulse in the conventional driving mode E illustrated in FIG. 11.

When the non-selection signal 26 and the black write signal 23 are applied, the voltage waveform has the level +1 for the first time interval “a” of the selection period T, the level of 0 for the time intervals “b” and “c”, the negative level −1 for the subsequent time interval “d”, and the level of 0 for the remaining time intervals “e” and “f”. The above-mentioned rectangular wave pulse of the negative level −1 is the parasitic signal 40. The above-mentioned rectangular wave pulse of the positive level +1 is a cancel pulse 41 having the pulse width and the amplitude that are the same as those of the parasitic signal 40 and the polarity that is opposite to that of the parasitic signal 40.

When the non-selection signal 26 and the white write signal 24 are applied, the voltage waveform has the positive level +1 for the first time interval “a” of the selection period T, the level of 0 for the subsequent time intervals “b” to “d”, the negative level −1 for the subsequent time interval “e”, and the level of for the remaining time interval “f”. The above-mentioned rectangular wave pulse of the negative level −1 is the parasitic signal 40. The above-mentioned rectangular wave pulse of the positive level +1 is the cancel pulse 41 having the pulse width and the amplitude that are the same as those of the parasitic signal 40 and the polarity that is opposite to that of the parasitic signal 40.

The cancel pulse 41 is generated by adding the additive pulse 35 to the selection signal 25 and adding the additive pulse 36 to the non-selection signal 26 in the driving mode E of the dot matrix display panel using bistable nematic liquid crystal illustrated in FIG. 11. The additive pulse 35 and the additive pulse 36 may be generated just by applying the positive potential +V34 from the common driving section 11 to the common terminal in the first time interval “a” of the selection period T. Even when the additive pulse 35 and the additive pulse 36 are generated, the selecting capability of the black display voltage 33 and the white display voltage 34 is not impaired.

The cancel pulse 41 is obtained by adding a pulse for generating a cancel pulse to the common selection signal applied to the common terminal at the time of selection and to the common non-selection signal applied to the common terminal at the time of non-selection at a timing at which the original waveforms are not deformed. The additive pulse 35 and the additive pulse 36 which are pulses for generating a cancel pulse are generated by controlling the control section 14 so as to select a specific driving potential of the common driving section 11 for a predetermined time period.

As is clear from comparison between FIGS. 11 and 12, the embodiment of the present invention cancels the direct current component due to the parasitic signal 40 caused at the time of non-selection by the cancel pulse 41 having the pulse width that is the same as that of the parasitic signal 40 and the polarity that is opposite to that of the parasitic signal 40. The cancel pulse 41 is generated by adding the additive pulse 35 to the common selection signal 25 and by adding the additive pulse 36 to the non-selection signal 26. Note that, the additive pulses 35 and 36 are the same.

FIG. 14 illustrates a waveform of the common-segment voltage of the bistable liquid crystal display panel when driven in the driving mode E according to the present invention illustrated in FIG. 12. As is clear from FIG. 14, when the driving is performed in the conventional driving mode E, the parasitic signal 40 and the cancel pulse 41 are applied to the whole surface of the bistable liquid crystal display panel at the time of non-selection. The cancel pulse 41 is a pulse having the pulse width and the amplitude that are the same as those of the parasitic signal 40 and the polarity that is opposite to that of the parasitic signal 40. Therefore, when the driving is performed in the driving mode E according to the present invention, the direct current component due to the parasitic signal is canceled by the cancel pulse. As a result, no “blur” is caused on the bistable liquid crystal display panel.

In addition, there is an advantage that, in generating the cancel pulse 41, it is not necessary to change any part of the hardware configuration of a conventional driving device, and the present invention may be implemented by partially changing software thereof. For example, when, as illustrated in FIG. 1, the driving device includes the common driving section 11 for driving the common lines in the lateral direction, the segment driving section 12 for driving the segment lines in the longitudinal direction, the power supply circuit 13 for generating the driving potentials (V0, V12, V34, V5, and VCX), and the control section 14 for controlling the common driving section 11, the segment driving section 12, and the power supply circuit 13, it is enough to partially change the software of the control section 14 for controlling the common driving section 11. Note that, in the embodiment, the cancel pulse 41 is a pulse having the pulse width that is the same as that of the parasitic signal 40 and the polarity that is opposite to that of the parasitic signal 40, and thus, is symmetrical with the parasitic signal 40, but strict symmetry is not necessarily required insofar as the “blur” is not practically significant.

By the way, a method of driving a dot matrix display panel using bistable nematic liquid crystal which may select white/black only by positive polarity driving or negative polarity driving to which the present invention may be applied is of various sorts as exemplified in FIGS. 7 to 10. Of those, driving modes to which the method according to the present invention may be applied are the positive polarity driving mode (Mode-B) and the negative polarity driving mode (Mode-D). It goes without saying that the present invention may be applied to positive polarity driving modes and negative polarity driving modes which are not illustrated here.

As described above, according to the present invention, a device for driving a dot matrix display panel using bistable nematic liquid crystal which operates so as to prevent a “blur” due to a parasitic signal from being caused may be provided without impairing the performance of rewriting the display and without significantly changing a conventional device for driving a dot matrix display panel using bistable nematic liquid crystal.

### INDUSTRIAL APPLICABILITY

The present invention may be used for all applications for liquid crystal display. In particular, when the present invention is used for an electronic shelf label or an electric paper, industrial applicability is high.

### REFERENCE SIGNS LIST

1 substrate
2 electrode
3 alignment film
4 nematic liquid crystal molecule
5 polarizing plate
10 bistable liquid crystal display panel
11 common driving section
12 segment driving section
13 power supply circuit
14 control section
21 signal for generating erase pulse
22 pulse for canceling direct current component
23 black write signal
24 white write signal
25 common selection signal
26 common non-selection signal
31 erase pulse
32 pulse for erasing direct current component
33 black display voltage
34 white display voltage
35, 36 additive pulse
37, 38 added portion
40 parasitic signal
41 cancel pulse
51 positive polarity driving range
52 negative polarity driving range
57 mixed range

1. A method of driving a dot matrix display panel using bistable nematic liquid crystal, the dot matrix display panel using bistable nematic liquid crystal comprising:
a pair of substrates opposed substantially in parallel to each other;
a plurality of common electrodes and a plurality of segment electrodes which are formed in matrix on surfaces on opposed surface sides of the pair of substrates, respectively;
alignment films formed on the plurality of common electrodes and the plurality of segment electrodes;
nematic liquid crystal molecules which are sandwiched by the alignment films, have two stable orientation states, and are bistable so that the two stable orientation states are maintained even when no electric field is applied; and
at least one polarizing plate provided outside the nematic liquid crystal molecules,
the method comprising:
applying any one of a selection signal for rewriting the nematic liquid crystal molecules and a non-selection signal from a common driving section, which is connected to the plurality of common electrodes, to the nematic liquid crystal molecules;
selectively applying a signal for selecting one of the two stable orientation states from a segment driving section, which is connected to the plurality of segment electrodes, to the nematic liquid crystal molecules; and
displaying an image based on common-segment voltages corresponding to electric fields between the plurality of common electrodes and the plurality of segment electrodes,
wherein the method further comprises, in order to cancel a parasitic signal caused by application of the non-selection signal from the common driving section and the signal from the segment driving section to the nematic liquid crystal molecules, applying a cancel pulse having an amount of charge that is substantially equal to that of the parasitic signal and a polarity that is opposite to that of the parasitic signal from the common driving section or the segment driving section during a period between input of a signal and the subsequent input of a signal to the nematic liquid crystal molecules.

2. A method of driving a dot matrix display panel using bistable nematic liquid crystal according to claim 1, wherein the cancel pulse has an amplitude and a pulse width that are substantially equal to those of the parasitic signal on the common-segment voltages.

3. (canceled)

4. A device for driving a dot matrix display panel using bistable nematic liquid crystal, the dot matrix display panel using bistable nematic liquid crystal comprising:
a pair of substrates opposed substantially in parallel to each other;
a plurality of common electrodes and a plurality of segment electrodes which are formed in matrix on surfaces on opposed surface sides of the pair of substrates, respectively;
alignment films formed on the plurality of common electrodes and the plurality of segment electrodes;
nematic liquid crystal molecules which are sandwiched by the alignment films, have two stable orientation states, and are bistable so that the two stable orientation states are maintained even when no electric field is applied; and
at least one polarizing plate provided outside the nematic liquid crystal molecules,
the device comprising:
a common driving section connected to the plurality of common electrodes;
a segment driving section connected to the plurality of segment electrodes; and
a control section for controlling a power supply circuit, for controlling application of any one of a selection signal for rewriting the nematic liquid crystal molecules and a non-selection signal from the common driving section connected to the plurality of common electrodes to the nematic liquid crystal molecules, and for controlling selective application of a signal for selecting one of the two stable orientation states from the segment driving section connected to the plurality of segment electrodes to the nematic liquid crystal molecules,
the device causing an image to be displayed based on common-segment voltages corresponding to electric fields between the plurality of common electrodes and the plurality of segment electrodes,
wherein the control section applies, in order to cancel a parasitic signal caused by application of the non-selection signal from the common driving section and the signal from the segment driving section to the nematic liquid crystal molecules, a cancel pulse having an amount of charge that is substantially equal to that of the parasitic signal and a polarity that is opposite to that of the parasitic signal from the common driving section or the segment driving section during a period between input of a signal and the subsequent input of a signal to the nematic liquid crystal molecules.

5. A device for driving a dot matrix display panel using bistable nematic liquid crystal according to claim 4, wherein the cancel pulse has an amplitude and a pulse width that are substantially equal to those of the parasitic signal on the common-segment voltages.

6. (canceled)
